(19) United States
(12) Patent Application Publication
(10) Pub. No.: US 2003/0132322 A1
(43) Pub. Date: Jul. 17, 2003

(54) Fuel Injector

(76) Inventors: Guenter Dantes, Eberdingen (DE); Detlef Nowak, Untergruppenbach (DE)

Correspondence Address: KENYON & KENYON, ONE BROADWAY, NEW YORK, NY, 10004, US

(21) Appl. No.: 10/203,069

(22) PCT Filed: Nov. 30, 2001
(86) PCT No.: PCT/DE01/04505

(30) Foreign Application Priority Data
Dec. 5, 2000 (DE) 100 60 290.8

(51) Int. Cl. B05B 1/30

(52) U.S. Cl. 239/585.1

(57) ABSTRACT

A fuel injector (1), especially for the direct injection of fuel into a combustion chamber of a mixture-compressing, spark-ignition internal combustion engine, having an actuator (10), a valve needle (3) that can be actuated by the actuator (10) for actuating a valve-closure member (4), which, together with a valve seat surface (6) configured on a valve seat body (5), forms a sealing seat, and a plurality of spray-discharge openings (7) that are configured in the valve seat body (5). A damping element (37) is arranged in a downstream-side cutout (36) of the valve-closure member (4).

### BACKGROUND INFORMATION

The present invention relates to a fuel injector according to the species of the main claim.

From German Patent 33 14 899 A1, an electromagnetically actuatable fuel injector is known, in which, for purposes of electromagnetic actuation, an armature cooperates with an electrically exciteable solenoid coil, and the stroke of the armature is transmitted by a valve needle to a valve-closure member. The valve-closure member cooperates with a valve seat surface to form a sealing seat. The armature is not rigidly attached to the valve needle, but rather is arranged on it so as to be axially movable. A first resetting spring acts upon the valve needle in the closing direction and therefore holds the fuel injector closed in the currentless, non-excited state of the solenoid coil. The armature is acted upon in the stroke direction by a second resetting spring, so that the armature in the idle position rests on a first stop provided on the valve needle. When the solenoid coil is excited, the armature is pulled in the stroke direction and takes the valve needle with it via the first stop. When the current exciting the solenoid coil is switched off, the valve needle is accelerated to its closing position by the first resetting spring, and it takes the armature with it via the described stop. As soon as the valve-closure member strikes against the valve seat, the closing motion of the valve needle is abruptly terminated. The motion of the armature, which is connected to the valve needle in a nonrigid fashion, is continued opposite the stroke direction, and it is absorbed by the second resetting spring, i.e., the armature swings through against the second resetting spring, which in comparison to the first resetting spring has a significantly lower spring constant. Finally, the second resetting spring accelerates the armature once again in the stroke direction.

One disadvantage in the fuel injector known from German Patent 33 14 899 A1 is especially the incomplete debouncing. If the armature strikes against the stop of the valve needle, this can result in a renewed momentary lifting off from the valve seat of the valve-closure member, connected to the valve needle, and therefore can result in an undesirable momentary opening of the fuel injector, as a result of which the jet image is falsified and the injected quantity of fuel is increased, having the consequence of higher fuel consumption and more intense knocking of the internal combustion engine as a result of afterburning.

A damping device between the valve seat body and the valve seat support is known from U.S. Pat. No. 5,236,173.

### ADVANTAGES OF THE INVENTION

In contrast, the fuel injector according to the present invention having the characterizing features of the main claim has the advantage that the rebound of the valve-closure member from the sealing seat is prevented by a damping element arranged in a cutout of the valve-closure member, without having to increase the spring constant of the resetting spring and, therefore, having to accept longer opening times.

Furthermore, in a simple manner, a multiple-hole concept can be employed without resulting in limitations, for example, when series components are used.

As a result of the measures indicated in the subclaims, advantageous refinements and improvements of the fuel injector indicated in the main claim are possible.

In this context, especially advantageous is the cost-effective and easy-to-manufacture cylindrical shape of the damping element, that can be manufactured from any elastic material, for example, rubber, silicon or foam, or the configuration of the damping element as a liquid cushion surrounded by a sleeve.

Also advantageous is the configuration of a plurality of rings of spray-discharge openings, which are partially covered by the damping element. As a result of this measure, it is possible to adjust the mixture cloud that is injected into the combustion chamber of the internal combustion engine in accordance with the operating state of the internal combustion engine.

This is advantageously supported by a different slope of the spray-discharge openings with respect to a longitudinal axis of the fuel injector.

Additionally advantageous is the configuration of the damping element in the form of a spring that is connected to a damping body, the spring being arranged in the cutout of the valve-closure member. In this context, the damping body that swings freely in the open state of the fuel injector can also be made of metal, because the damping effect is achieved by the spring. In this context, one advantage is especially the cost-effective manufacturing, as no special demands are placed on the material of the damping element.

### DRAWING

Exemplary embodiments of the present invention are depicted in simplified form in the drawing and are discussed in greater detail in the description below. The following are the contents:

FIG. 1 depicts an axial section of a first exemplary embodiment of a fuel injector according to the present invention,

FIG. 2A depicts an enlarged segment of the first exemplary embodiment depicted in FIG. 1 of a fuel injector according to the present invention in the area IIA in FIG. 1,

FIG. 2B depicts a second exemplary embodiment of a fuel injector according to the present invention in the same area as FIG. 2A, and

FIG. 2C depicts a third exemplary embodiment of a fuel injector according to the present invention in the same area as FIGS. 2A and 2B.

### DESCRIPTION OF THE EXEMPLARY EMBODIMENTS

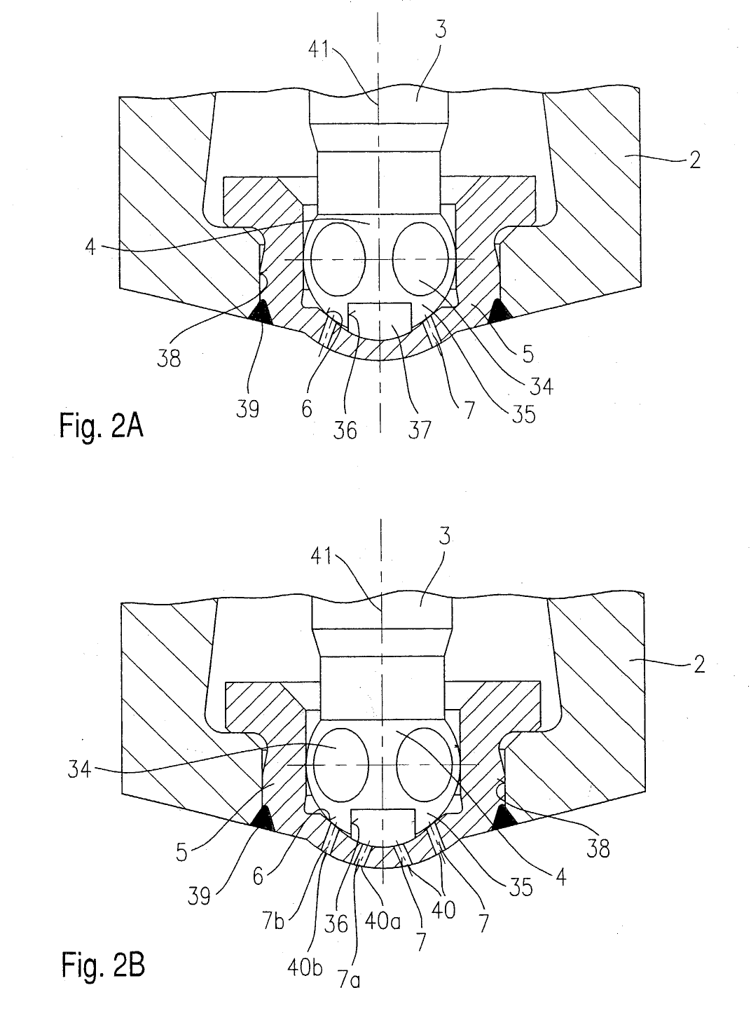

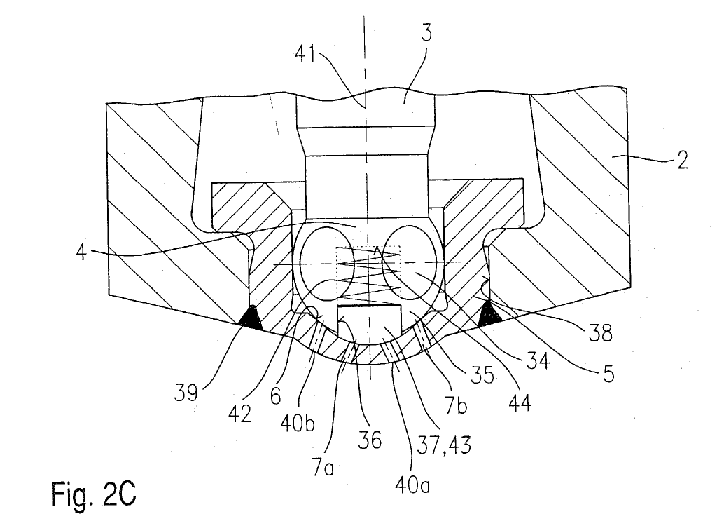

Before the exemplary embodiments of fuel injector 1 according to the present invention are described in greater detail on the basis of FIGS. 2A through 2C, fuel injector according to the present invention is first briefly explained in an general presentation with respect to its essential components, in order to achieve a better understanding of the present invention.

Fuel injector 1 is realized in the form of a fuel injector for fuel-injection systems of mixture-compressing, spark-ignition internal combustion engines. Fuel injector 1 is especially well-suited for the direct injection of fuel into an undepicted combustion chamber of an internal combustion engine.

Fuel injector 1 includes a nozzle body 2, in which a valve needle 3 is arranged. Valve needle 3 has an operative connection to the valve-closure member 4, which cooperates with a valve seat surface 6, arranged on a valve seat body 5, to form a sealing seat. In the exemplary embodiment, fuel injector 1 is a fuel injector 1 that opens to the inside, which has available a plurality of preferably annular spray-discharge openings 7. Nozzle body 2 is sealed by a seal 8 against an external pole 9 of a magnetic circuit. A solenoid coil 10 is encased in a coil housing 11 and is wound on a coil support 12, which contacts an interior pole 13 of the magnetic circuit. Interior pole 13 and exterior pole 9 are separated from each other by a gap 26 and are supported on a connecting component 29. Solenoid coil 10 is excited, over a line 19, by an electrical current that can be supplied via an electrical plug-in contact 17. Plug-in contact 17 is surrounded by a plastic casing, which can be injection-molded on interior pole 13.

Valve needle 3 is guided in a valve-needle guide 14, which is executed in a disk shape. A paired-off adjustment disk 15 functions to adjust the stroke. Located on the other side of adjusting disk 15 is armature 20. The latter has a force-locking connection to valve needle 3 via a first flange 21, the valve needle being joined to first flange 21 by a welded seam 22. Supported on first flange 21 is a resetting spring 23, which in the present design of fuel injector 1 is prestressed by a sleeve 24.

A second flange 31, which is joined to valve needle 3 by a welded seam 33, acts as a lower armature stop. An elastic intermediate ring 32, which contacts second flange 31, prevents rebounding when fuel injector 1 is closed.

Running in valve-needle guide 14 and in armature 20 are fuel channels 30a through 30b. Spherical valve-closure member 4 in the preferred exemplary embodiment has at least one polished section 34, through which the fuel circumflows valve-closure member 4 and is conveyed to spray-discharge openings 7. The fuel is conveyed via a central fuel supply 16 and is filtered by a filter element 25. Fuel injector 1 is sealed by a seal 28 against a fuel line that is not depicted further.

Valve-closure member 4 on a spray-discharge-side end 35 has a cutout 36, which is preferably given a cylindrical or pot-like shape. Arranged in cutout 36 is a damping element 37, which is supported on valve seat body 5 on the spray-discharge side. In the present first exemplary embodiment, damping element 37 in this context is arranged so that, within spray-discharge openings 7, having an annular configuration in valve seat body 5, the damping element contacts valve seat body 5. A detailed description of the first exemplary embodiment of the fuel injector 1 according to the present invention and of its mode of functioning are provided on the basis of FIG. 2A.

In the resting state of fuel injector 1, armature 20 is acted upon by resetting spring 23 in opposition to its stroke direction, so that valve-closure member 4 is held in a sealing position on valve seat 6. When solenoid coil 10 is excited, it generates a magnetic field, which moves armature 20 in the stroke direction in opposition to the spring force of resetting spring 23, the stroke being determined by working gap 27 located, in the resting position, between interior pole 13 and armature 20. Armature 20 also takes with it in the stroke direction flange 21, which is welded to valve needle 3. Valve-closure member 4, having an operative connection to valve needle 3, lifts off valve seat surface 6, and the fuel is spray-discharged.

If the coil current is switched off, armature 20, after a sufficient decay of the magnetic field, falls away from interior pole 13 due to the pressure of resetting spring 23, as a result of which flange 21, which has an operative connection to valve 3, moves in opposition to the stroke direction. As a result, valve needle 3 is moved in the same direction, valve-closure member 4 thus being placed on valve seat surface 6 and fuel injector 1 being closed. In this context, a rebound of valve-closure member 4 from valve seat body 5 is prevented by damping element 37, which absorbs the kinetic energy of valve needle 3.

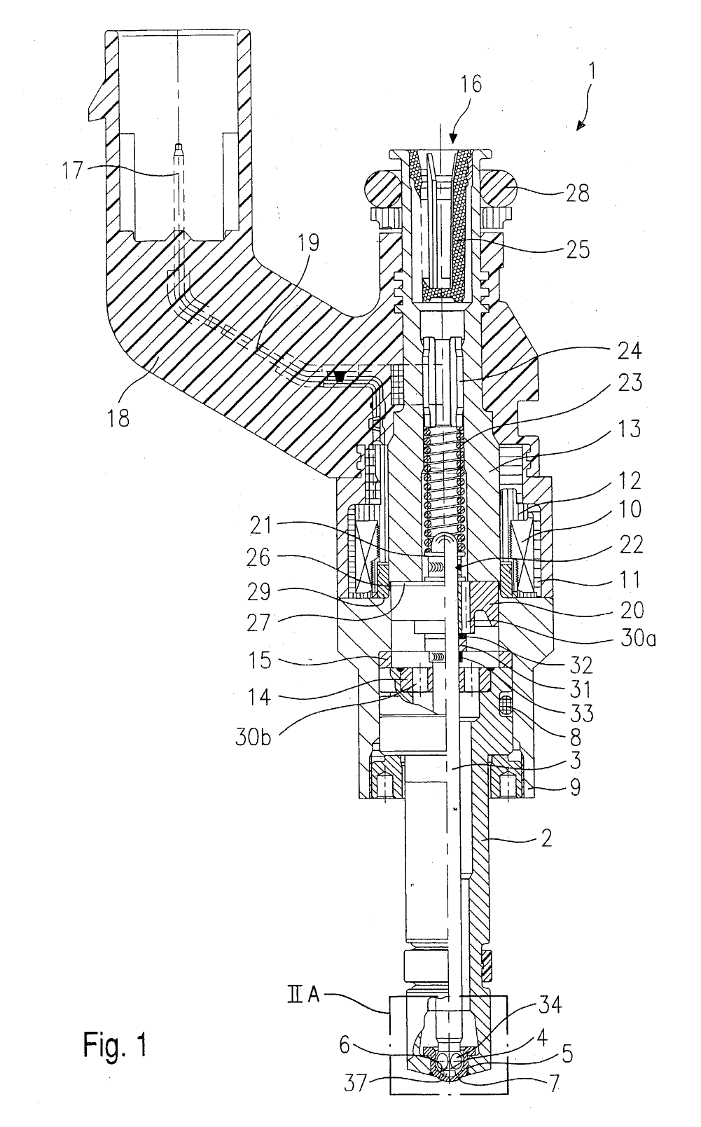

FIG. 2A in a partial cutaway representation depicts the area designated as IIA in FIG. 1. In this context, the same components are provided with the same reference numerals, for easier orientation.

As was already briefly described on the basis of FIG. 1, valve-closure member 4 of fuel injector 1 configured in accordance with the present invention has a virtually spherical shape. As a result, an shift-free, cardanic valve-needle guide is achieved, which provides for an exact mode of functioning of fuel injector 1. This is especially important with regard to avoiding a rebound using damping element 37, when fuel injector 1 is closed.

Valve seat body 5 of fuel injector 1 is configured in a virtually pot-like shape and, through its shape, contributes to the valve needle guide. In this context, valve seat body 5 is inserted in a spray-discharge-side cutout 38 of nozzle body 2 and is joined to nozzle body 2 by a welded seal 39.

Valve-closure member 4 at its spray-discharge-side end 35 has a cutout 36, which is configured in a pot-like or cylindrical fashion and which opens in a downstream direction. Arranged in cutout 36 is above-mentioned damping element 37. The latter is preferably made of an elastic rubber or plastic material and is dimensioned so that its axial length is somewhat greater than the axial length of cutout 36 in valve-closure member 4.

In the closed state of fuel injector 1, damping element 37 is compressed by the force of resetting spring 23, which holds fuel injector 1 closed, so that valve-closure member 4 is held in a sealing position on valve seat surface 6, and damping element 37 in its axial length is slightly reduced.

Upon the actuation of actuator 10 of fuel injector 1, executed in the exemplary embodiment as solenoid coil 10, valve-closure member 4 lifts off from the sealing seat, fuel therefore flowing via at least one polished section 34 to spray-discharge openings 7. The expansion of damping element 37, in response to the opening motion, delivers an additional contribution to the rapid opening of fuel injector 1. In this context, damping element 37 can be secured in cutout 36 of valve-closure member 4 and as a result can also lift off from valve seat body 5 in response to the further opening motion, but it can also be arranged loosely in cutout 36 and can remain on valve seat body 5 when fuel injector 1 is opened. In this case, it must be assured that the opening stroke of fuel injector 1 does not exceed the axial length of damping element 37 in the relaxed state, because otherwise damping element 37 can slide out of cutout 36.

When fuel injector 1 is closed, armature 20, after a sufficient decay of the magnetic field, falls away from internal pole 13 as a result of the force of resetting spring 23, valve needle 3 therefore being moved in the downstream direction. Valve closure member 4 is therefore once again placed back in its initial position, damping element 37 being compressed at the end of the closing process and as a result exerting a force on valve-closure member 4, which acts in opposition to the closing direction and brakes the motion of valve needle 3. As a result, valve-closure member 4 strikes the sealing seat at a very small residual speed, thus counteracting a further undesirable momentary opening of fuel injector 1.

FIG. 2B, in a partial cutaway representation, depicts a second exemplary embodiment of a fuel injector 1 configured in accordance with the present invention. The segment is the same as in FIG. 2A. The same components are provided with the same reference numerals.

In contrast to the first exemplary embodiment of fuel injector 1 as depicted in FIGS. 1 and 2A, the second exemplary embodiment depicted in FIG. 2B has two especially concentric rings 40 of spray-discharge openings 7. In this context, inner spray-discharge openings 7a of an inner ring 40a are covered by damping element 37, whereas outer spray-discharge openings 7b of an outer ring 40b are arranged analogously to the first exemplary embodiment described in FIG. 2A.

Damping element 37 can also be configured analogously to the exemplary embodiment described in FIG. 2A, damping element 37 having to be secured in cutout 36 in the present second exemplary embodiment, so that inner ring 40a of inner spray-discharge openings 7a is released when fuel injector 1 is opened.

Thus if solenoid coil 10 is supplied with current, valve-closure member 4 lifts off first from valve seat surface 6, as a result of which outer spray-discharge openings 7b of outer ring 40b are released. Only when a preestablished stroke has been traversed, which corresponds to the difference between the axial length of damping element 37 in the relaxed state and the axial length of cutout 36, does damping element 37 also lift off from valve seat body 5, inner spray-discharge openings 7a of inner ring 40a thus being released.

As a result of the aforementioned arrangement of spray-discharge openings 7, it can be achieved that the fuel cloud injected into the combustion chamber, depending on the stroke position of valve needle 3, is only composed of fuel which was spray-discharged from outer spray-discharge openings 7b of outer ring 40b, or that a fuel cloud is formed which contains components both from inner spray-discharge openings 7a of inner ring 40a and from outer spray-discharge openings 7b of outer ring 40b.

This is advantageous especially for the shaping of the mixture cloud, because the shape of the mixture cloud as well as its stoichiometry can be directly influenced, for example, by a different angle of spray-discharge openings 7 with respect to a longitudinal axis 41 of fuel injector 1. By connecting and disconnecting rings 40 of spray-discharge openings 7, it is possible to generate a jet image that is adjusted to the specific operating state of fuel injector 1. The necessary stroke stages can be achieved by further armature stops, such as a driving sleeve or a fuel injector 1 having two actuators 10, for example, as a result of a double coil valve.

Therefore, if outer spray-discharge openings 7b of outer ring 40b are inclined at a small angle with respect to longitudinal axis 41 of fuel injector 1, then, in a first switch position of fuel injector 1, when spray-discharge openings 7a of inner ring 40a are closed, a mixture cloud results that has a small jet opening angle and high combustion chamber penetration, such as are required for the partial load range. In contrast, inner spray-discharge openings 7a of inner ring 40a are pitched at a steeper angle, so that for full-load operation, when inner spray-discharge openings 7a of inner ring 40a are opened, a fuel cloud is injected into the combustion chamber which has components having a large radial proportion, so that the jet opening angle is greater than in the case of the partial load operation, and the mixture cloud therefore fills the combustion chamber in a homogeneous fashion.

This exemplary embodiment therefore combines the advantages of avoiding the rebound, and therefore reducing the dispersion of the metered fuel quantity, with the possibility of modeling the jet image as a function of the operating state of fuel injector 1.

In FIG. 2C, a third exemplary embodiment of a fuel injector 1 configured in accordance with the present invention is depicted, which also has two rings 40a and 40b of spray-discharge openings 7a and 7b. The segment is once again selected as in FIG. 2A and 2B; the same components are provided with the same reference numerals.

In contrast to the first and second exemplary embodiments described in FIGS. 2A and 2B, in the present third exemplary embodiment, rebound avoidance is achieved by a combination of a damping body 43 and a spring 42, which is arranged between an end face 44 of cutout 36 and damping body 43. The combination of spring 42 and damping body 43 constitutes damping element 37. In the closed state of fuel injector 1, spring 42 is prestressed, so that damping element 37 terminates flush with valve-closure member 4. If fuel injector 1 is actuated, once again valve-closure member 4 lifts off first from the sealing seat, as a result of which outer ring 40b of outer spray-discharge openings 7b is opened, whereas damping body 43, at first under the tension of spring 42, is held in a sealing position on valve seat body 5. In the further course of the opening stroke, spring 42 is increasingly relieved of stress, until damping body 43 also lifts off from valve seat body 5 and, as a result, inner ring 40a of inner spray-discharge openings 7a is released.

When fuel injector 1 is closed, damping body 43 is first set on inner ring 40a of spray-discharge openings 7a. The closing motion from this time point is braked by spring 42, which is arranged in valve-closure member 4, because as the spring compression increases, the resetting force of spring 42 also increases. As a consequence, rebounds are avoided.

The present invention is not limited to the exemplary embodiments depicted and in particular can be used in fuel injectors 1 having piezoelectrical or magnetostrictive actuators 10 and for any shapes and materials of damping element 37 as well as any number of spray-discharge openings 7.

What is claimed is:

1. A fuel injector (1), especially for the direct injection of fuel into a combustion chamber of a mixture-compressing, spark-ignition internal combustion engine, having an actuator (10), a valve needle (3) that can be actuated by the actuator (10) for actuating a valve-closure member (4), which, together with a valve seat surface (6) that is configured on a valve seat body (5), forms a sealing seat, and at least one spray-discharge opening (7) that is configured in the valve seat body (5), wherein a damping element (37) is arranged in a downstream-side cutout (36) of the valve-closure member (4).

2. The fuel injector as recited in claim 1, wherein the damping element (37) is configured in cylindrical fashion.

3. The fuel injector as recited in claim 1 or 2, wherein the damping element (37) is made of an elastic material.

4. The fuel injector as recited in one of claims 1 through 3, wherein the damping element (37), in a closed state of the fuel injector (1), is compressed.

5. The fuel injector as recited in one of claims 1 through 4, wherein the axial extension of the damping element (37), in an opened state of the fuel injector (1), is longer than the axial extension of the cutout (36) in the valve-closure member (4).

6. The fuel injector as recited in one of claims 1 through 5, wherein the spray-discharge openings (7) in the valve seat body (5) are arranged in a ring (40), so that the spray-discharge openings (7) are not covered by the damping element (37).

7. The fuel injector as recited in claim 6, wherein a radial diameter of the damping element (37) is smaller than a radial diameter of the ring (40) of spray-discharge openings (7).

8. The fuel injector as recited in one of claims 1 through 7, wherein an inner ring (40a) of inner spray-discharge openings. (7a) and an outer ring (40b) of outer spray-discharge openings (7b) is configured in the valve seat body (5).

9. The fuel injector as recited in claim 8, wherein the inner ring (40a) of inner spray-discharge openings (7a), in the closed state of the fuel injector (1), is covered by the damping element (37).

10. The fuel injector as recited in claim 8 or 9, wherein the inner spray-discharge openings (7a) of the inner ring (40a) of the fuel injector (1) and the outer spray-discharge openings (7b) of the outer ring (40b) are inclined at different angles with respect to a longitudinal axis (41).

11. The fuel injector as recited in claim 10, wherein the inclination of the inner spray-discharge openings (7a) is greater than the inclination of the outer spray-discharge openings (7b).

12. The fuel injector as recited in claim 1, wherein the damping element (37) is made up of a spring (42) and a damping body (43) that is acted upon by the spring (42).

13. The fuel injector as recited in claim 12, wherein the spring (42) is supported on an end face (44) of the cutout (36).

14. The fuel injector as recited in claim 12 or 13, wherein the spring (42), in the closed state of the fuel injector (1), is compressed.

15. The fuel injector as recited in claim 14, wherein the spring (42), in the opened state of the fuel injector (1), is released.
